(19) United States
(12) Patent Application Publication
(10) Pub. No.: US 2026/0365873 A1
(43) Pub. Date: Nov. 19, 2026

(54) CURABLE COMPOSITIONS BASED ON HIGH ACID VALUE POLYURETHANES

(71) Applicant: PPG Industries Ohio, Inc., Cleveland, OH (US)

(72) Inventors: Hilary Ann Kerchner, Allison Park, PA (US); Hongying Zhou, Allison Park, PA (US); Scott Joseph Moravek, Mars, PA (US); Paul Hubert Lamers, Allison Park, PA (US); Francis Patrick Cassidy, Pittsburgh, PA (US); Visham Appadoo, Cranberry Township, PA (US); Rachel Elizabeth Ramsey, Pittsburgh, PA (US); Chad Alan Landis, Oakmont, PA (US)

(73) Assignee: PPG Industries Ohio, Inc., Cleveland, OH (US)

(21) Appl. No.: 19/483,090

(22) PCT Filed: May 10, 2024
(86) PCT No.: PCT/US2024/028976

§ 371 Date: Nov. 10, 2025

Related U.S. Application Data
(60) Provisional application No. 63/502,003, filed on May 12, 2023.

(51) Int. Cl. C09D 175/04; C08G 18/10; C08G 18/28; C08G 18/32; C08G 18/34; C08G 18/83

(52) U.S. Cl. CPC C09D 175/04; C08G 18/10; C08G 18/288; C08G 18/3275; C08G 18/348; C08G 18/831; C08G 18/833

(57) ABSTRACT

Curable compositions include a polyurethane resin having acid functional groups. The polyurethane resin may have an acid value of at least 75 mg KOH on resin solids. A method of preparing a polyurethane resin includes reacting an isocyanate and a polyol to form a polyurethane prepolymer and reacting the polyurethane prepolymer with an isocyanate reactive group to form a polyurethane resin having acid functional groups. The curable composition may be cured via carbodiimide, epoxy, oxazoline, and/or aziridine mechanisms.

### CROSS-REFERENCE TO RELATED APPLICATION

This application claims the benefit of priority of U.S. Provisional Application 63/502,003 filed May 12, 2023, under 35 U.S.C. 119, titled “Curable Compositions Based on High Acid Value Polyurethanes”, which is incorporated herein by reference.

### FIELD

The present disclosure relates to a curable composition including a high acid value polyurethane resin. The curable composition is curable via carbodiimide, epoxy, oxazoline, and/or aziridine cure systems.

### BACKGROUND

Curable compositions are used as coatings, adhesives, and sealants for a wide variety of industrial applications such as automotive, protective and marine, commercial transportation, consumer electronics, and many others for decorative and functional applications. They are curable such that they are of low enough viscosity for application but increase in molecular weight via crosslinking during and/or after application. This dramatically improves the properties of the curable composition as compared to its precursors.

Known curable compositions may contain volatile organic compounds. “Volatile organic compound” or “VOC” typically means any organic compound that volatilizes before, during or after cure of the curable mixture. VOCs are often regulated to certain limits based on the specific application of the coating being used. The regulatory landscape of VOCs has continued to change and limit VOCs in curable compositions.

### SUMMARY

The present disclosure provides a curable composition including a polyurethane resin having acid functional groups. The polyurethane resin may have an acid value of at least 75 mg KOH on resin solids. The curable composition may further include one of a carbodiimide, an epoxy, oxazoline, and an aziridine.

### DETAILED DESCRIPTION

The present disclosure provides a curable composition, which may alternatively be referred to as a coating composition, and a method of making. The curable composition of the present disclosure exhibits high solvent resistance and includes a high acid value polyurethane, and one of a carbodiimide, an epoxy, an oxazoline, or an aziridine.

### I. DEFINITIONS

For purposes of the following detailed description, it is to be understood that the disclosure may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” For example, numerical ranges provided for weight percentages of components or amounts of components added should be construed as being modified by the term “about.” Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges from (and including) the recited minimum value of 1 to the recited maximum value of 10, that is, having a minimum value equal to or greater than 1 and a maximum value of equal to or less than 10.

The use of the singular includes the plural and plural encompasses singular, unless specifically stated otherwise. In addition, the use of “or” means “and/or” unless specifically stated otherwise, even though “and/or” may be explicitly used in certain instances.

“Acid value on solids,” when used herein, indicates a quantified acidity of a given chemical substance based on the milligrams (mg) of potassium hydroxide (KOH) required to neutralize the acidic constituents in 1 gram of the non-volatile components.

Unless otherwise indicated, ambient conditions of temperature and pressure are ambient temperature (20-25 °C, such as 23 °C) and standard pressure of 101.3 kPa (1 atm) at a relative humidity in the air of 35% to 75%, such as 55%.

As used herein the terms “cure” and “curing” refer to the use of a compound (a “curing agent”) that is able to participate in a chemical reaction that results in crosslinking and/or polymerization between monomers, oligomers, pre-polymers and/or polymers.

As used herein the terms “curing agent”, “crosslinker”, and “crosslinking agent” refer to compounds that are able to participate in a chemical reaction that results in crosslinking and/or polymerization between monomers, oligomers, pre-polymers and/or polymers.

“Isocyanate equivalent weight” and “NCO equivalent weight” as used herein refers to, unless otherwise stated, the isocyanate (NCO) equivalent weight (in grams per equivalent; g/eq) determined using ASTM D2572-19 (Standard Methods of Isocyanate Groups in Urethane Materials or Prepolymers) revised as described herein.

As used herein, the terms “flash” or “flash off” refers to removal of solvents, that allow an applied coating composition to remain in a liquid state, to evaporate.

As used herein, the terms “Multi-functional” and “Difunctional”, refers to a molecule having more than two, or two functional groups, respectively, as a nonlimiting example, when used in connection with carbodiimides, meaning that more than one carbodiimide functionality is present per molecule.

Unless otherwise indicated, as used herein, the term “molecular weight” refers to a weight average molecular weight (“Mw”) as determined by gel permeation chromatography (GPC) using appropriate polystyrene standards. If a number average molecular weight (“Mn”) is specified, the weight is determined in the same GPC manner, while calculating a number average from the thus obtained polymer molecular weight distribution data. As a nonlimiting example, Mn refers to the total weight of a material divided by the number of molecules in the material and can be determined using gel permeation chromatography. Unless otherwise noted, Mw and Mn are in units of g/mol. As used herein the term “organic solvent” refers to carbon containing molecules, nonlimiting examples including esters, ketones, glycol ethers, alcohols, hydrocarbons and mixtures thereof that are capable of dissolving or dispersing other substances at ambient conditions.

As used herein the prefix “poly” refers to two or more. As a nonlimiting example, a polyisocyanate refers to a compound that includes two or more isocyanate groups and a polyol refers to a compound that includes two or more hydroxyl groups.

“Polymer” and “Polymeric” refer to oligomers, polymers, homopolymers (e.g., prepared form a single monomer species), copolymers (e.g., prepared form at least two monomer species), terpolymers (e.g., prepared from at least three monomer species), and graft polymers.

“Resin solids” refers to the non-volatile components that make up the binder or film-forming components of the composition. As used herein, a weight percentage based on “resin solids” refers to an amount of a component based on a total weight of the binder or film-forming components of a composition.

“Solids” refers to the non-volatile components present in a composition of volatile and non-volatile components. As used herein, a weight percentage based on “solids” refers to an amount of a component based on a total weight of the non-volatile components of a composition determined by comparing an initial sample weight with a final sample weight after exposure to 110 °C for one hour.

As used herein, the term “solvent” refers to a substance capable of dissolving or dispersing other substances at ambient conditions.

As used herein, the term “surfactant” refers to a substance that, when added to a liquid, reduces its surface tension, thereby increasing its spreading and wetting properties.

### II. POLYURETHANE RESIN

Polyurethanes can be used as a primary binder or film-forming resin in curable compositions and can be formed from a polyisocyanate and a polyol. Polyurethanes may be acid functional, such as, without limitation, by incorporation of acid containing polyols, hydroxy acids, such as hydroxy pivalic acid, and/or mercapto acids, such as 3-mercaptopropionic acid.

The acid groups of the polyurethane may be neutralized to enable aqueous dispersion of the polyurethane. The resulting polyurethane resin dispersion may be cured into a final coating using a variety of suitable curing pathways.

The present disclosure provides methods for preparing polyurethanes. The polyurethane can be prepared by reacting, as nonlimiting examples, a polyester polyol, polyether polyol or acrylic polyol with a polyisocyanate and optionally an acid functional polyol (such as, without limitation, dimethylol propionic acid) such that the NCO/OH stoichiometric ratio is greater than 1:1 to generate an NCO functional prepolymer. The terminal isocyanates can then be reacted with a non-tertiary aminoalcohol such as, without limitation, diethanolamine or ethanolamine to produce a terminal OH functional polymer. Some or all of the terminal OH groups may then be reacted with anhydrides such as, without limitation, succinic anhydride or methylhexahydrophthalic anhydride to produce a urethane polymer with terminal COOH groups. Alternatively, the terminal isocyanate group can be reacted with an acid monomer. The acid groups introduced in the first stage of urethane preparation are considered to be internal COOH groups, while the acid groups introduced after reaction of the anhydride with an aminoalcohol are considered to be terminal COOH groups. The acid functional polyurethane polymers may be neutralized with a tertiary alkylated amine prior to and/or after contact with water to provide water dispersibility.

An acid functional polyurethane utilizing a ring opening of a cyclic anhydride can occur by forming a prepolymer from an isocyanate, an isocyanate reactive compound such as a non-acid containing polyol, an acid containing polyol, and/or combinations thereof. After formation of the prepolymer, a reactive amine including hydroxyl groups and/or polyol may be added to react with the remaining unreacted isocyanate groups and an acid monomer such as an anhydride may be reacted with hydroxyl groups of the prepolymer, and a neutralizing amine may be used to disperse the polyurethane into water.

The polyurethane may also be formed from an excess of isocyanate, an isocyanate reactive compound such as, without limitation, an acid containing polyol, and optionally a non-acid containing polyol. The prepolymer may then be reacted with a non-acid containing isocyanate reactive compound which may include hydroxyl groups, thiol groups, and/or non-tertiary amine groups and may be followed by reacting with a neutralizing amine to disperse the polyurethane into water.

The polyurethane may also be formed by incorporating an acid onto the polyurethane resin. A prepolymer may be formed from an isocyanate, an isocyanate reactive compound such as an acid containing polyol, a non-acid containing polyol, and/or combinations thereof. An acid monomer may then be reacted with the remaining isocyanate groups of the prepolymer, and a neutralizing amine may be used to disperse the polyurethane into water.

The curable composition of the present disclosure includes a high acid value (for example greater than 75 mg KOH on resin solids) polyurethane resin. The polyurethane can be prepared, as outlined above without limitation, by reacting a polyester polyol, polyether polyol or acrylic polyol with a polyisocyanate and an acid functional polyol (such as dimethylol propionic acid) such that the NCO/OH ratio is greater than 1:1 to generate an NCO functional prepolymer. The terminal isocyanates may then be reacted in one of a number of methods described herein to generate terminal COOH groups. The acid functional polyurethane polymers can then be used in a curable composition or can be neutralized with amine and dispersed into water and then be used in a curable composition.

The polyurethane resin may have a weight average molecular weight greater than 1,000 g/mol and a number average molecular weight (Mn) of at least 400 g/mol, such as at least 500 g/mol, or at least 1000 g/mol, at least 1000 g/mol, or at least 2000 g/mol, or at least 3000 g/mol and up to 50,000 g/mol g/mol, such as up to 40,000 g/mol, or up to 30,000 g/mol, or up to up to 5000, or within any range using any two of the foregoing values as endpoints, such as from 400 g/mol to 50,000 g/mol, or from 500 g/mol to 40,000 g/mol, or from 1000 g/mol to 30,000 g/mol, as determined by gel permeation chromatography using polystyrene standards.

The polyurethane resin includes acid groups. The polyurethane resin may additionally include, hydroxyl groups, thiol groups, or any combination of the foregoing.

The acid value of the polyurethane resin may be determined using a Metrohm 798 MPT Titrino automatic titrator, manufactured by Metrohm AG, according to ASTM D4662-15. The value may be then divided by the content of solids to result in acid value on solids. The polyurethane resin used according to the present disclosure can have an acid value on solids greater than 75 mg KOH/g, greater than 80 mg KOH/g, greater than 85 mg KOH/g, greater than 90 mg KOH/g, greater than 95 mg KOH/g, greater than 100 mg KOH/g, on resin solids, or within any range using any two of the foregoing values as endpoints, such as 75 mg KOH/g to 100 mg KOH/g, 80 mg KOH/g to 95 mg KOH/g, or 85 mg KOH/g to 90 mg KOH/g. Acid values may be determined using a Metrohm 798 MPT Titrino automatic titrator, manufactured by Metrohm AG (Herisau, Switzerland), according to ASTM D 4662-15, then divided by the solids content to results in acid value on solids. The high acid value can improve the solvent resistance of coating compositions using the high acid value polyurethane resins.

The curable composition of the present disclosure may include an amount of polyurethane resin from 20 wt. %, such as from 30 wt. %, or from 40 wt. %, or from 50 wt. %, or from 60 wt. % up to 70 wt. %, such as up to 80 wt. %, or up to 85 wt. %, or within any range using any two of the foregoing values as endpoints, such as from 20 wt. % to 85 wt. %, or from 30 wt. % to 80 wt. %, or from 30 wt. % to 70 wt. %, where wt. % is based on total resin solids.

### A. Polyurethane Resin Formation

The polyurethane resin of the present disclosure may be formed from a polyol, an acid containing diol, and an excess of polyisocyanate in a first stage to form a prepolymer. The prepolymer may then be further modified with a nontertiary amine, polyol, and/or acid monomer to form the polyurethane resin according to the methods described below.

i. Polyisocyanate/Diisocyanate

The polyurethane resin of the present disclosure may include a polyisocyanate, such as a diisocyanate, reactive with the polyol and the acid containing diol.

Suitable polyisocyanates, include, but are not limited to aliphatic, aromatic, cycloaliphatic or heterocyclic isocyanates. Suitable aliphatic isocyanates may include trimethylene, tetramethylene, pentamethylene, hexamethylene, 1,2-propylene, 1,2-butylene, 2,3-butylene and 1,3-butylene diisocyanates; the cycloalkylene compounds such as 1,3-cyclopentane, 1,4-cyclohexane, 1,2-cyclohexane diisocyanates and isophorone diisocyanates; the aromatic compounds such as m-phenylene, p-phenylene, 4,4′-diphenyl, 1,5-naphthalene and 1,4-naphthalene diisocyanates; the aliphatic-aromatic compounds such as 4,4′-diphenylene methane, 2,4- or 2,6-tolylene, or mixtures thereof, 4,4′-toluidine, tetramethyl xylylene, and xylylene diisocyanates; the nuclear-substituted aromatic compounds such as dianisidine diisocyanate, 4,4′-diphenylether diisocyanate and chlorodiphenylene diisocyanate; the triisocyanates such as triphenyl methane-4,4′,4″-triisocyanate, 1,3,5-triisocyanato benzene and 2,4,6-triisocyanato toluene; and the tetraisocyanates such as 4,4′-dimethyldiphenyl methane-2,2′,5,5′-tetraisocyanate; the polymerized polyisocyanates such as tolylene diisocyanate dimers and trimers, and the like.

Suitable diisocyanates can also include diisocyanates having a single aromatic or cycloaliphatic ring such as isophorone diisocyanate (IPDI), tetramethyl xylene diisocyanate (TMXDI), 4,4′-methylene dicyclohexyl diisocyanate (H12MDI), 1,6-hexamethylene diisocyanate (HDI), 1,3-bis(isocyanato methyl)cyclohexane, 1,5-diisocyanato-2-methylpentane, 1,6-diisocyanato-2,2,4-trimethylhexane, 1,6-diisocyanato-2,4,4-trimethylhexane, 1,4-diisocyanatobutanone, tri-methyl-hexamethylene diisocyanate, 1,8-diisocyanatooctane, 1,12-diisocyanatododecane, 1,8-diisocyanto-2,4-dimethyloctane, 1,4-bis(isocyanato methyl)cyclohexane, trans-1,4-cyclohexylene diisocyanate, and 2,4-diisocyanato-1-methyl cyclohexane.

Other suitable aliphatic diisocyanates may also include, methyl-2,6-diisocyanatohexanoate, bis(isocyanatomethyl)cyclohexane, 1,3-bis(isocyanatomethyl)cyclohexane, 2,5(6)-bis(isocyanatomethyl)cyclo[2.2.1.]heptane, 1,3,3-trimethyl-1-(isocyanatomethyl)-5-isocyanatocyclohexane, octahydro-4,7-methano-1H-indenedimethyl diisocyanate, and 1,1′-methylenebis(4-isocyanatocyclohexane).

The polyurethane may be made from a monomer mixture that includes an amount of polyisocyanate of from 15 wt. %, such as from 20 wt. %, or from 25 wt. %, or from 30 wt. % up to 65 wt. %, such as up to 50 wt. %, or up to 40 wt. %, or within any range using any two of the foregoing values as endpoints, such as from 15 wt. % to 65 wt. %, or from 20 wt. % to 55 wt. %, or from 25 wt. % to 50 wt. %, or from 30 wt. % to 40 wt. %, where wt. % is based on total resin solids.

When forming the prepolymer, the molar ratio of isocyanate functional groups of the polyisocyanate to hydroxyl functional groups of the acid containing polyol and the non-acid containing polyol may be greater than 1.

ii. Polyol/Diol

The polyurethane resin of the present disclosure may be formed from a polyol reactive with the polyisocyanate and/or an acid containing polyol.

“Polyol” refers to a compound having two or more hydroxyl groups, such as two, three or four hydroxyl groups. The hydroxyl groups of the polyol may be connected by a bridging group selected from: an alkylene group; an alkenylene group; an alkynylene group; or an arylene group. The polyol may lack acid groups, such as a non-acid containing polyol.

Polyols include, but are not limited to the following: alkylene glycols, such as ethylene glycol; propylene glycol; diethylene glycol; dipropylene glycol; triethylene glycol; tripropylene glycol; hexylene glycol; polyethylene glycol; polypropylene glycol and neopentyl glycol; hydrogenated bisphenol A; cyclohexanediol; propanediols including 1,2-propanediol; 1,3-propanediol; butyl ethyl propanediol; 2-methyl-1,3-propanediol; and 2-ethyl-2-butyl-1,3-propanediol; butanediols including 1,4-butanediol; 1,3-butanediol; and 2-ethyl-1,4-butanediol; pentanediols including trimethyl pentanediol and 2-methylpentanediol; cyclohexanedimethanol; hexanediols including 1,6-hexanediol; caprolactonediol (such as the reaction product of epsilon-caprolactone and ethylene glycol); hydroxyalkylated bisphenols; polyether glycols, such as poly(oxytetramethylene) glycol; trimethylol propane; pentaerythritol; di-pentaerythritol; trimethylol ethane; trimethylol butane; dimethylol cyclohexane; glycerol and the like or combinations thereof.

Hydroxy functional polyesters, and poly(meth)acrylates include but are not limited to polyols reactive with the polyisocyanate in the formation of the polyurethane resin. As used herein and as will be understood by one skilled in art the term “(meth)acrylate” denotes both the acrylate and the corresponding (meth)acrylate. The poly(meth)acrylate can be any suitable poly(meth)acrylate and mixtures thereof. The poly(meth)acrylate may include di(meth)acrylate, tri(meth)acrylate, tetra(meth)acrylate, and/or one or more other ethylenically unsaturated radically polymerizable monomers. Mixtures of poly(meth)acrylate monomers may also be used, including mixtures of mono, di, tri, and/or tetra(meth)acrylate.

Diols include, but are not limited to the following: ethylene glycol; 1,2-propane diol; 1,3-propane diol; 1,2-butandiol; 1,3-butandiol; 1,4-butandiol; but-2-ene 1,4-diol; 2,3-butane diol; 2-methyl 1,3-propane diol; 2,2′-dimethyl 1,3-propanediol (neopentyl glycol); 1,5 pentane diol; 3-methyl 1,5-pentanediol; 2,4-diethyl 1,5-pentane diol; 1,6-hexane diol; 2-ethyl 1,3-hexane diol; diethylene glycol; triethylene glycol; dipropylene glycol; tripropylene glycol; 2,2,4-trimethyl pentane 1,3-diol; 1,4 cyclohexane dimethanol; tricyclodecane dimethanol; 2,2,4,4-tetramethyl cyclobutane 1,3-diol; isosorbide; 1,4-cyclohexane diol; 1,1′-isopropylidene-bis(4-cyclohexanol); and mixtures thereof.

Suitable diols may include polyether diols such as Terathane® 200 and Terathane® 650 available from Invista or the PolyTHF® polyether diols available from BASF.

The polyurethane may be made from a monomer mixture that includes an amount of a polyol of from 15 wt. %, such as from 20 wt. %, or from 25 wt. % up to 40 wt. %, such as up to 35 wt. %, or up to 30 wt. %, or within any range using any two of the foregoing values as endpoints, such as from 15 wt. % to 40 wt. %, or from 20 wt. % to 35 wt. %, or from 25 wt. % to 30 wt. %, where wt. % is based on total resin solids.

The polyol/diol may be a non-acid containing polyol, meaning the polyol lacks acid groups.

When forming the prepolymer, the molar ratio of hydroxyl functional groups of a non-acid containing polyol and/or an acid containing polyol to isocyanate functional groups of the polyisocyanate may be less than 1.

iii. Acid Containing Polyol

The polyurethane resin of the present disclosure may include an acid containing polyol reactive with the polyisocyanate and the polyol.

Acid containing polyol may include dimethylolpropionic acid, 2,2-bis(hydroxymethyl) butyric acid, tartaric acid, 3,5-dihydroxybenzoic acid, ascorbic acid and its isomers, and any acid derivatives of the polyols listed in the previous section II (A) (ii).

The formation of the polyurethane may be made from a monomer mixture that includes an amount of acid containing diol of from 5 wt. %, such as from 10 wt. %, or from 15 wt. % up to 30 wt. %, such as up to 25 wt. %, or up to 20 wt. %, or within any range using any two of the foregoing values as endpoints, such as from 5 wt. % to 30 wt. %, or from 10 wt. % to 25 wt. %, or from 15 wt. % to 20 wt. %, where wt. % is based on total resin solids.

iv. Amine

The polyurethane resin may further include reactive amines that react with isocyanate groups and/or neutralizing amines to neutralize hydrogens of the resin for dispersibility in aqueous media.

a. Reactive Amine

When an amine includes a hydrogen bonded to nitrogen that is reactive with an isocyanate, it is considered a “reactive amine”.

Suitable reactive amines include, but are not limited to primary and/or secondary amino groups as well as hydroxyl groups alkanolamines such as methanol amine, ethanol amine, propanol amine, isopropanol amine, dimethanol amine, diethanol amine, dipropanol amine, diisopropanol amine, N-methylethanolamine, and aminomethyl propanol. Suitable reactive amines may also include non-alkanolamines such as diethyl amine, dimethyl amine, triethyl amine, and dibutyl amine.

The polyurethane resin of the present disclosure may include an amount of an amine that reacts with the isocyanate of from 1 wt. %, such as from 2 wt. %, or from 4 wt. % up to 12 wt. %, such as up to 10 wt. %, or up to 8 wt. % or within any range using any two of the foregoing values as endpoints, such as from 1 wt. % to 12 wt. %, or from 2 wt. % to 10 wt. %, or from 4 wt. % to 8 wt. %, where wt. % is based on a total weight of the polyurethane resin.

The molar ratio of isocyanate functional groups of the polyisocyanate to the amine groups of the reactive amine may be greater than or equal to 1.

b. Neutralizing Amine

“Neutralizing amine” and like terms indicate an amine that may be utilized to neutralize at least some of the resin to make the resin more water soluble. Suitable neutralizing amines may include ammonia. Suitable neutralizing amines may include secondary amines, such as diethyl amine. Further, suitable neutralizing amines may include tertiary amines, such as triethyl amine, triethylamine, tributylamine, dimethylethanolamine, triethanolamine, 1,4-diazabicyclo[2.2.2]octane, 1,8-diazabicyclo[5.4.0]undec-7-ene, tripropylamine, and diisopropylethylamine.

The neutralizing amine may affect the reactivity of the resin, such as by neutralizing the reactive acid group thereby limiting the reactivity of the acid group.

The neutralizing amine can be present in an amount necessary to at least partially neutralize the acid groups in the polyurethane resin. A 100 percent neutralization means that the mole ratio of neutralizing amine to acid is 1:1.

During the formation of the polyurethane resin of the present disclosure, an amount of acid may be neutralized by the neutralizing amine of from 40%, such as from 60%, or from 80% up to 120%, such as up to 100%, or up to 95% or within any range using any two of the foregoing values as endpoints, such as from 40-120%, or from 40-100%, or from 40-95% or from 60-100%, or from 80-95%, where wt. % is based on of the number of acid groups in the polyurethane resin.

v. Solvent

The polyurethane resin may itself be formed in a solvent medium and/or additional solvent may be added to the polyurethane resin to adjust the concentration of the polyurethane resin to form a polyurethane resin composition. The solvent or solvent medium may include one or more solvents.

Suitable solvents include, but are not limited to organic solvents, such as ester, ketone, glycol ether, alcohol, hydrocarbon or mixtures thereof. Suitable ester solvents can include methyl esters such and succinate, adipate, and glutarate methyl esters and alkyl acetates such as ethyl acetate, n-butyl acetate, n-hexyl acetate, and mixtures thereof. Diesters, such as dimethyl esters can also be included as solvent, including without limitation dimethyl succinate, dimethyl glutarate and dimethyl adipate. Suitable ketone solvents may include methyl ethyl ketone, methyl isobutyl ketone, and mixtures thereof. Suitable hydrocarbon solvents may include toluene, xylene, aromatic hydrocarbons, and aliphatic hydrocarbons such as hexane, heptanes, and nonane.

The polyurethane resin composition may include an amount of solvent of from 0 wt. %, such as from 5 wt. %, or from 10 wt. % and up to 95 wt. %, such as up to 90 wt. %, or up to 85 wt. % or within any range using any two of the foregoing values as endpoints, such as from 0 wt. % to 95 wt. %, or from 0 wt. % to 90 wt. %, or from 5 wt. % to 85 wt. %, where wt. % is based on a total weight of the polyurethane resin composition (e.g. 20 wt. % solvent equates to 80 wt. % resin solids).

### B. Polyurethane Formation: Anhydride Ring Opening

An acid functional polyurethane utilizing a ring opening of a cyclic anhydride occurs by forming a prepolymer from an isocyanate, an isocyanate reactive compound such as a non-acid containing polyol, an acid containing polyol, and/or combinations thereof. After formation of the prepolymer, a reactive amine including hydroxyl groups and/or polyol may be added to react with the remaining unreacted isocyanate groups and an acid monomer such as an anhydride may be reacted with hydroxyl groups of the prepolymer, and a neutralizing amine may be used to disperse the polyurethane into water.

### C. Polyurethane Formation: Increased Acid Containing Diol

The polyurethane may also be formed from an excess of isocyanate, an isocyanate reactive compound such as an acid containing polyol, and optionally a non-acid containing polyol. The prepolymer may then be reacted with a non-acid containing isocyanate reactive compound which may include hydroxyl groups, thiol groups, and/or non-tertiary amine groups and may be followed by reacting with a neutralizing amine to disperse the polyurethane into water.

### D. Polyurethane Formation: Incorporation of an Acid

The polyurethane may also be formed by incorporating an acid onto the polyurethane resin. A prepolymer may be formed from an isocyanate, an isocyanate reactive compound such as an acid containing polyol, a non-acid containing polyol, and/or combinations thereof. Then, an acid monomer can be reacted with the remaining isocyanate groups of the prepolymer, and a neutralizing amine may be used to disperse the polyurethane into water.

Suitable acid monomers include, but are not limited to hydroxy acids, such as hydroxy pivalic acid, and mercapto acids, such as 3-mercaptopropionic acid, 2-mercaptopropionic acid, 2-mercaptoacetic acid, and a monomer resulting from the ring opening of methylhexahydrophthalic anhydride (mHHPA) with neopentyl glycol (NPG).

### III. CURABLE COMPOSITION FORMULATIONS AND CURING

Curable compositions of the present disclosure including high acid value polyurethanes may be cured via one or more reactive cure pathways such as with carbodiimide, epoxy, aziridine, and oxazoline, or combinations thereof, acting as curing agents or crosslinkers.

The curable composition may be a coating composition, an adhesive composition, or a sealant composition.

### A. Carbodiimide

The curable composition may contain a polycarbodiimide that can be multi- or at least di-functional and reactive with the carboxylic acid in the resin during and/or after flash and amine volatilization of the curable composition to form a crosslinked composition. The curable composition may contain a water dispersible polycarbodiimide. In order to utilize certain carbodiimides in the present disclosure, it may be necessary to modify the carbodiimides to make them water dispersible. Techniques for modifying carbodiimides to make them water dispersible are well known in the art.

As used herein, the term “multifunctional carbodiimide” or “polycarbodiimide” refers to a polymer containing two or more units having the structure: —N═C═N—. As will be appreciated, polycarbodiimides can generally be prepared by a condensation reaction of a polyisocyanate in the presence of a suitable catalyst to form a polycarbodiimide intermediate having terminal NCO-functionalities and by terminating and/or chain extending the polycarbodiimide intermediate by the addition of one or more compounds including reactive hydrogen atoms, such as an amine and/or a hydroxy-containing compound.

The polycarbodiimide polymers can be made by any of a variety of methods starting from a polycarbodiimide intermediate having terminal NCO-functionalities. Moreover, the polycarbodiimide polymers can be produced from a polycarbodiimide intermediate made with or without use of a reactive hydrogen-containing chain extender.

To prepare a polycarbodiimide, an isocyanate terminated polycarbodiimide intermediate may be first formed by a condensation reaction of a polyisocyanate, which may or may not have been previously chain extended by the reaction of a polyisocyanate with an active-hydrogen containing chain extender of the type previously described. The polyisocyanate may be condensed with the elimination of carbon dioxide to form the isocyanate terminated polycarbodiimide.

The resulting polycarbodiimide, which may or may not be chain extended, has terminal isocyanate groups. The isocyanate terminated polycarbodiimide can then be further reacted or capped by reacting the terminal isocyanate groups with a reactive hydrogen-containing hydrophilic compound to impart hydrophilicity to the polycarbodiimide enabling it to be dispersed in water, or other compound to impart hydrophobic capacity to the polycarbodiimide.

Muti-functional carbodiimides may be commercially available. Suitable carbodiimides may include UCARLINK XL-29SE, XL-20 commercially available from Union Carbide, CARBODILITE V-02-L2 commercially available from Nisshinbo Industries, Inc. and Picassian® XL-732 from Stahl may be used in the present disclosure.

The carbodiimide of the present disclosure may be linear or branched.

The curable composition may include a stoichiometric ratio of acid (such as from the polyurethane resin) to carbodiimide of from at least 1:20 to 20:1, such as from 1:10 to 10:1, such as from 1:7 to 7:1, such as from 1:5 to 5:1, or from 1:4 to 4:1, or from 1:3 to 3:1, or from 1:2 to 2:1 or from 1.0:1.3 to 1.3:1.0 or any ratio within the range of the foregoing ratios.

The curable composition formed with a carbodiimide may include an amount of carbodiimide of from 5 wt. %, such as from 10 wt. %, or from 20 wt. %, or from 30 wt. %, and up to 60 wt. %, such as up to 50 wt. %, or up to 40 wt. %, or within any range using any two of the foregoing values as endpoints, such as from 5 wt. % to 60 wt. %, or from 10 wt. % to 50 wt. %, or from 20 wt. % to 40 wt. %, where wt. % is based on the resin solids of the curable composition.

### B. Epoxy

The curable composition of the present disclosure may contain an epoxy that is reactive with the carboxylic acid multi- or at least di-functionality in the polyurethane resin to form a crosslinked composition. Suitable epoxies include, but are not limited to compounds having two or more epoxy groups in the molecule, such as, resorcinol diglycidyl ether, neopentyl glycol diglycidyl ether, 1,6-hexanediol diglycidyl ether, glycerol, polyglycidyl ether, hydrogenated bisphenol A diglycidyl ether, bisphenol A diglycidyl ether, trimethyl propane polyglycidyl ether, pentaerythritol polyglycidyl ether, sorbitol polyglycidyl ether, and polypropylene glycol diglycidyl ether.

Other epoxies include epoxy functional polymers, such as those derived from one or more of ethylenically unsaturated monomers containing epoxy groups, such as glycidyl acrylate, glycidyl methacrylate and allyl glycidyl ether.

Suitable epoxies may be commercially available. EPON 828, EPON1001F, and EPONEX1510 are commercially available from Westlake Epoxy. ERISYS GE-60 is commercially available from CVC Thermoset Specialties. DENACOL EX-614B is commercially available from Nagase America LLC.

The curable composition may include a stoichiometric ratio of acid (such as from the polyurethane resin) to epoxy of from at least 1:10 to 10:1, such as from 1:7 to 7:1, such as from 1:5 to 5:1, or from 1:4 to 4:1, or from 1:3 to 3:1, or from 1:2 to 2:1 or from 1.0:1.3 to 1.3:1.0 or any ratio within the range of the foregoing ratios.

The curable composition formed with epoxy may include an amount of an epoxy of from 15 wt. %, such as from 30 wt. %, or from 40 wt. %, and up to 70 wt. %, such as up to 60 wt. %, or up to 50 wt. %, or within any range using any two of the foregoing values as endpoints, such as from 15 wt. % to 70 wt. %, or from 30 wt. % to 60 wt. %, or from 40 wt. % to 50 wt. %, where wt. % is based on resin solids of the curable composition.

### C. Aziridine

The curable composition of the present disclosure may contain an aziridine that is reactive with the carboxylic acid multi- or at least di-functionality in the polyurethane resin to form a crosslinked composition. The aziridine may be a polyaziridine, such as propylene imine-based polyaziridine, trimethylolpropane tris(2-methyl-1-aziridine propionate), ethylene imine-based polyaziridine, and trimethylolpropane tris(2-methyl-1-aziridine propionate).

The aziridine may include a multifunctional polymeric aziridine crosslinker.

Suitable aziridine cross-linkers include, but are not limited to compounds having two or more aziridinyl groups in the molecule, such as, tetramethylolmethanetris (β-aziridinyl propionate) and trimethylolpropane tris (β-aziridinyl propionate).

A polyaziridine can be characterized by an average aziridine functionality from 2.1 to 6, from 2.1 to 5, from 2.1 to 4, from 2.1 to 3, or from 2.3 to 3. A polyaziridine can be characterized by an average aziridine functionality greater than 2.1, greater than 2. 3, greater than 2.5, greater than 2.7, greater than 2.9, greater than 4, or greater than 5. A polyaziridine can be characterized by an average aziridine functionally less than 6, less than 5, less than 4, less than 3, or less than 2.8, or less than 2.5.

The curable composition may include a stoichiometric ratio of acid (such as from the polyurethane resin) to aziridine of from at least 1:10 to 10:1, such as from 1:7 to 7:1, such as from 1:5 to 5:1, or from 1:4 to 4:1, or from 1:3 to 3:1, or from 1:2 to 2:1 or from 1.0:1.3 to 1.3:1.0 or any ratio within the range of the foregoing ratios.

The curable composition formed with aziridine may include an amount of a aziridine of from 15 wt. %, such as from 30 wt. %, or from 40 wt. %, and up to 70 wt. %, such as up to 60 wt. %, or up to 50 wt. %, or within any range using any two of the foregoing values as endpoints, such as from 15 wt. % to 70 wt. %, or from 30 wt. % to 60 wt. %, or from 40 wt. % to 50 wt. %, where wt. % is based on resin solids of the curable composition.

### D. Oxazoline

The curable composition of the present disclosure may contain an oxazoline that is reactive with the carboxylic acid multi-functionality in the polyurethane resin to form a crosslinked or cured composition. The oxazoline may be a polyoxazoline.

The polyoxazoline may function as a crosslinking agent for the present compositions. Suitable monomeric polyoxazolines can include a bis-oxazoline and/or a tris-oxazoline. The monomeric polyoxazolines can have the following structure:

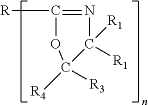

where n can be an integer of 2 to 4; R can be an n-valent organic group such as an arylene or an alkylene radical; each R₁, R₂, R₃ and R₄ can independently be the same or different and each independently may be selected from hydrogen, and substituted or unsubstituted C₁-C₄ alkyl groups such as methyl, ethyl, propyl and butyl.

Suitable polyoxazolines include, but are not limited to 1,2-phenylene-bis-oxazoline, 1,3-phenylene-bis-oxazoline, 1,4-phenylene-bis-oxazoline, 1,2-bis(oxazolinyl-4-methyl)benzene, 1,3-bis(oxazolinyl-4-methyl)benzene, 1,4-bis(oxazolinyl-4-methyl)benzene, 1,2-bis(oxazolinyl-5-ethyl)benzene, 1,3-bis(oxazolinyl-5-methyl)benzene, 1,3-bis(oxazolinyl-5-ethyl)benzene, 1,4-bis(oxazolinyl-5-ethyl)benzene, 1,2,4-tris(oxazolinyl)benzene, 1,3,5-tris(oxazolinyl)benzene, and 1,2,4,5-tetrakis(oxazolinyl)benzene, as well as acrylic-based oxazoline functionalized reactive copolymers.

The high acid functional polyurethane resin polymer and polyoxazoline may be apportioned in the curable polyurethane composition such that the equivalents of polyoxazoline to the equivalents of carboxylic acid functionality may be in a molar ratio of 0.05:1 to 5:1 such as 0.5:1 to 2.0:1, or 1:1, or any ratio within the ranges of the foregoing ratios.

The curable composition formed with oxazoline may include an amount of a oxazoline of from 15 wt. %, such as from 30 wt. %, or from 40 wt. %, and up to 70 wt. %, such as up to 60 wt. %, or up to 50 wt. %, or within any range using any two of the foregoing values as endpoints, such as from 15 wt. % to 70 wt. %, or from 30 wt. % to 60 wt. %, or from 40 wt. % to 50 wt. %, where wt. % is based on resin solids of the curable composition.

### E. Additives

The curable composition of the present disclosure may further include one or more additives. Such additives can include solvents, surfactants, surface agents, catalysts, water, colorants including pigments and/or dyes, plasticizers, antioxidants, hindered amine light stabilizers, UV light absorbers and stabilizers, surfactants, flow control agents, thixotropic agents, fillers, organic cosolvents, reactive diluents, leveling agents, defoamers, grind vehicles, and other customary auxiliaries.

The curable composition of the present disclosure can include a catalyst, such as a basic catalyst.

Suitable catalysts include, without limitation, zinc, amines, quaternary ammonium compounds, phosphonium containing compounds, and/or quaternary phosphonium group containing compounds. Suitable quaternary phosphonium group containing compounds include, without limitation, ethyltriphenylphosphomium iodide.

Any suitable basic catalyst can be used in the present coating composition. Suitable basic catalysts include, without limitation, include primary, secondary and/or tertiary amines, such as triethyl amine and aldimine.

When the basic catalyst includes an amine, the amine can include, without limitation, a tertiary amine, tetramethyl guanidine, 1,4-dihydropyrimidines, 1,8-diaza-bicyclo[5.4.0]undec-7-ene, 1,4-diaza-bicyclo[2.2.2]octane, dimethyl cocoamine, and 2-alkyl-N-alkyl imidazolines.

The curable composition can include the catalyst in an amount of from 0.1 wt. %, such as from 0.5 wt. %, or from 1 wt. %, up to 5 wt. %, such as up to 4.5 wt. %, or up to 4 wt. %, or within any range using any two of the foregoing values as endpoints, such as from 0.1 wt. % to 5 wt. %, such as from 0.1 wt. % to 4.5 wt. %, or from 0.5 wt. % to 4 wt. %, where wt. % is based on the resin solids of the coating composition.

### IV. CURABLE COMPOSITION APPLICATION AND CURING

The curable composition of the present disclosure may be applied to an article or substrate using spray coating, roller coating, coil coating, dip coating, precision coating, or spin coating techniques. The curable composition may be deposited over at least a part of a surface of the article and cured to form a cured layer.

The curable compositions of the present disclosure may be curable at a temperatures of from 0 °C, such as from 20 °C, or from 40 °C, or from 60 °C, or from 80 °C, or from 100 °C and up to 120 °C, such as up to 140 °C, or up to 160 °C, or up to 215 °C, or up to 225 °C, or up to 240 °C, or up to 260 °C, or within any range using any two of the foregoing values as endpoints, such as from 0 °C to 260 °C, or from 20 °C to 240 °C, or from 40 °C to 225 °C, or from 60 °C to 225 °C, or from 80 °C to 215 °C, or from 100 °C to 215 °C. The curable compositions can be cured for from 5 seconds to 48 hours, such as from 5 seconds to 24 hours, or from 10 seconds to 12 hours, or from 1 minute to 12 hours, or from 1.5 minutes to 12 hours, or from 1.75 minutes to 12 hours. Optionally, prior to curing the applied curable composition can be flashed at a temperature of from 10 °C to 80 °C, such as from 20 °C to 60 °C, or from 20 °C to 40 °C, or from 20 °C to 30 °C for from 5 to 60 minutes, such as from 5 to 30 minutes.

As will be understood by one skilled in the art, the time and temperature used for curing will be adjusted according to the needs of the particular application. For example, the application can include coil coatings which can be cured for short times at high temperatures, as a nonlimiting example, for 5 to 20 seconds at 180 to 220 °C. Another nonlimiting example may be an automotive application where curable compositions of the present disclosure may be cured at a temperature of from 80 °C to 140 °C for from 10 minutes to 1 hour. In a further example, such as automotive refinish or industrial applications, the curable compositions of the present disclosure may be cured at a temperature of rom 0 to 80 °C for from 5 minutes to 48 hours.

### V. PROPERTIES OF THE CURABLE COMPOSITION

Curable compositions formed using the present disclosure may exhibit increased resistance to solvents as compared to the precursors of the curable composition. The curable composition of the present disclosure may be entirely free of VOC.

To test the resistance of a curable composition, a substrate coated with the curable composition may be subjected to a solvent resistance test as described below.

A solvent resistance test may be performed by placing a test panel on a flat table or other suitable flat, firm surface. Two sterile gauze pads may be affixed over the end of a one-pound Ball-Peen hammer. The gauze may be affixed such that it is snugly held in place with a rubber band and has four layers of gauze over the end of the hammer with no wrinkles.

The gauze is saturated with an appropriate solvent, such as methyl ethyl ketone (MEK), for the substrate being tested. The gauze is re-saturated every 25 double rubs.

The substrate coated with the curable composition is immediately rubbed with the saturated gauze over the test area using a back-and-forth stroke of 2-4 inches. The weight of the hammer controls the downward pressure.

The back-and-forth strokes may be continued, counting one “double rub” for each forward and backward motion completed until the bare substrate is exposed in the center of the strip where the rubs are performed or until 100 double rubs are achieved.

The number of “double rubs” are recorded as the test result. The gauze should be removed and replaced with new gauze in between each sample tested.

The curable composition of the present disclosure may have a solvent resistance of at least 70 MEK double rubs, at least 80 MEK double rubs, at least 90 MEK double rubs, or at least 100 MEK double rubs.

### ASPECTS

A first aspect is directed to a curable composition that comprises:
a polyurethane resin having acid functional groups, the polyurethane resin having an acid value of at least 75 mg KOH, on resin solids according to ASTM D 4662-15.

A second aspect is directed to a curable composition that comprises:
a polyurethane resin having acid functional groups, the polyurethane resin having an acid value of at least 90 mg KOH, such as at least 100 mg KOH on resin solids according to ASTM D 4662-15.

A third aspect is directed to the curable composition of aspects 1 or 2, further comprising at least one of water, an organic solvent, and combinations thereof.

A fourth aspect is directed to the curable composition of any preceding aspect, further comprising an amine, such as a catalytic amine and/or a neutralizing amine.

A fifth aspect is directed to the curable composition of aspect 4, where the amine is a tertiary amine.

A sixth aspect is directed to the curable composition of either of aspects 4 or 4 where the amine is one or both of a catalytic amine or a neutralizing amine.

A seventh aspect is directed to the curable composition of any preceding aspect, where the polyurethane resin has a number average molecular weight, of from 400 g/mol to 50,000 g/mol determined by gel permeation chromatography using polystyrene standards.

An eighth aspect is directed to the curable composition of any preceding aspect, where the polyurethane resin has a number average molecular weight, of from 500 g/mol to 40,000 g/mol, such as from 1000 g/mol to 30,000 g/mol determined by gel permeation chromatography using polystyrene standards.

A ninth aspect is directed to the curable composition of any preceding aspect, where the curable composition comprises the polyurethane resin at from 20 wt. % to 85 wt. %, where wt. % is based on total resin solids.

A tenth aspect is directed to the curable composition of any preceding aspect, where the curable composition comprises the polyurethane resin at from 30 wt. % to 80 wt. %, such as from 30 wt. % to 70 wt. %, where wt. % is based on total resin solids.

An eleventh aspect is directed to the curable composition of any preceding aspect, where the acid functional groups comprise the residue of an acid monomer that comprises an anhydride, and/or an isocyanate reactive group.

A twelfth aspect is directed to the curable composition of any preceding aspect, further comprising at least one of a carbodiimide, an epoxy, an oxazoline, and an aziridine.

A thirteenth aspect is directed to the curable composition of any preceding aspect, where the polyurethane resin is part of a polyurethane resin composition comprising from 0 wt. % to 95 wt. %, of an organic solvent, where wt. % is based on a total weight of the polyurethane resin composition.

A fourteenth aspect is directed to the curable composition of any preceding aspect, where the polyurethane resin is part of a polyurethane resin composition comprising from 0 wt. % to 90 wt. %, such as from 5 wt. % to 85 wt. %, of an organic solvent, where wt. % is based on a total weight of the polyurethane resin composition.

A fifteenth aspect is directed to the curable composition of any preceding aspect, comprising a catalyst, such as zinc, an amine, a quaternary ammonium compound, a phosphonium containing compound, and/or a quaternary phosphonium group containing compound in an amount of from 0.1 wt. % to 5 wt. where wt. % is based on the resin solids of the coating composition.

An sixteenth aspect is directed to the curable composition of any preceding aspect, comprising a catalyst, such as zinc, an amine, a quaternary ammonium compound, a phosphonium containing compound, and/or a quaternary phosphonium group containing compound in an amount of from 0.1 wt. % to 4.5 wt. %, such as from 0.5 wt. % to 4 wt. %, where wt. % is based on the resin solids of the coating composition.

A seventeenth aspect is directed to the curable composition of any preceding aspect, where the acid functional groups comprise the residue of an acid monomer comprising one or both of a hydroxy acid and a mercapto acid, such as hydroxy pivalic acid, 3-mercaptopropionic acid, 2-mercaptopropionic acid, and/or 2-mercaptoacetic acid.

An eighteenth aspect is directed to an article comprising the curable composition of any one of aspects 1-17 deposited over at least a part of a surface of the article and cured to form a cured layer.

A nineteenth aspect is directed to the article of aspect 18, where the cured layer has a solvent resistance of at least 100 MEK double rubs.

A twentieth aspect is directed to the a method of preparing a polyurethane resin that comprises:
reacting a polyisocyanate with an acid containing polyol to form a polyurethane prepolymer; and
reacting the polyurethane prepolymer with an isocyanate reactive group to form a polyurethane resin having acid functional groups, the polyurethane resin having an acid value of at least 75 mg KOH on resin solids according to ASTM D 4662-15.

A twenty-first aspect is directed to the method of aspect 20, where the first reacting step further comprises reacting a polyisocyanate with the acid containing polyol and a non-acid containing polyol to form a polyurethane prepolymer.

A twenty-second aspect is directed to the method of aspect 21, where a molar ratio of isocyanate functional groups of the polyisocyanate to hydroxyl functional groups of the acid containing polyol and the non-acid containing polyol is greater than 1.

A twenty-third aspect is directed to the method of any one of aspects 20-22-16, further comprising neutralizing the polyurethane resin with a neutralizing amine, such as from 40-120% of the acid groups in the polyurethane resin.

A twenty-fourth aspect is directed to the method of any one of aspects 20-22-16, further comprising neutralizing the polyurethane resin with a neutralizing amine, such as from 40-100%, such as from 40-95% or from 60-100%, or from 80-95%, of the acid groups in the polyurethane resin.

A twenty-fifth aspect is directed to the method of either of aspect 23 or 24, where the neutralizing amine is selected from a tertiary amine, ammonia, and combinations of the foregoing.

A twenty-sixth aspect is directed to the method of any one of aspects 20-25, further comprising dispersing the polyurethane resin in water.

A twenty-seventh aspect is directed to the method of any one of aspects 20-26, where the isocyanate reactive group is diethanol amine.

A twenty-eighth aspect is directed to a method of preparing a polyurethane resin that comprises:
reacting a polyisocyanate with a polyol to form a polyurethane prepolymer; and
reacting the polyurethane prepolymer with an isocyanate reactive group comprising hydroxyl groups; and
reacting the hydroxyl groups of the isocyanate reactive group with an acid monomer to form a polyurethane resin having acid functional groups, the polyurethane resin having an acid value of at least 75 mg KOH on resin solids according to ASTM D 4662-15.

A twenty-ninth aspect is directed to the method of aspect 28, where the polyol comprises at least one of a non-acid containing polyol, an acid containing polyol, and a combination of the non-acid containing polyol and an acid containing polyol.

A thirtieth aspect is directed to the method of either aspect 28 or aspect 29, where the acid monomer comprises an anhydride.

A thirty-first aspect is directed to the method of any one of aspects 28 through 30, further comprising neutralizing the polyurethane resin with a neutralizing amine.

A thirty-second aspect is directed to the method of any one of aspects 28 through 31, where the neutralizing amine is a tertiary amine.

A thirty-third aspect is directed to the method of any one of aspects 28 through 32, further comprising dispersing the polyurethane resin in water.

A thirty-fourth aspect is directed to the method of any one of aspects 28 through 33, where the isocyanate reactive group is diethanol amine.

A thirty-fifth aspect is directed to a method of preparing a polyurethane resin that comprises:
reacting a polyisocyanate with a polyol to form a polyurethane prepolymer; and
reacting the polyurethane prepolymer with an acid monomer to form a polyurethane resin having acid functional groups, the polyurethane resin having an acid value of at least 75 mg KOH on resin solids according to ASTM D 4662-15.

A thirty-sixth aspect is directed to the method of aspect 35, where the polyol comprises at least one of a non-acid containing polyol, an acid containing polyol, and a combination of the non-acid containing polyol and acid containing polyol.

A thirty-seventh aspect is directed to the method of either aspect 35 or aspect 36, where the acid monomer is one or both of a hydroxy acid and a mercapto acid, such as hydroxy pivalic acid, 3-mercaptopropionic acid, 2-mercaptopropionic acid, and/or 2-mercaptoacetic acid.

A thirty-eighth aspect is directed to the method of any one of aspects 35 through 37, further comprising neutralizing the polyurethane resin with a neutralizing amine.

A thirty-ninth aspect is directed to the method of any one of aspects 35 through 38, where the neutralizing amine is a tertiary amine.

A fortieth aspect is directed to the method of any one of aspects 35 through 39, further comprising dispersing the polyurethane resin in water.

A forty-first aspect is directed to the method of any one of aspects 35 through 40, where the polyol comprises a polyester polyol, polyether polyol, acrylic polyol or combinations thereof.

A forty-second aspect is directed to a method of coating a substrate that comprises applying the curable composition of any one of aspects 1 through 17 over at least a part of a substrate using spray coating, roller coating, coil coating, dip coating, precision coating, or spin coating techniques and curing the curable composition to form a cured layer.

A forty-third aspect is directed to the method according to aspect 42, where the curable composition is cured at a temperatures of from 0 °C to 260 °C for from 5 seconds to 48 hours.

A forty-fourth aspect is directed to the method according to aspect 42, where the curable composition is cured at a temperatures of from 20 °C to 240 °C, such as from 40 °C to 225 °C, or from 60 °C to 225 °C, or from 80 °C to 215 °C, or from 100 °C to 215 °C for from 5 seconds to 24 hours, such as from 10 seconds to 12 hours, or from 1 minute to 12 hours, or from 1.5 minutes to 12 hours, or from 1.75 minutes to 12 hours.

A forty-fifth aspect is directed to the method according to any of aspects 42-44, where prior to curing the applied curable composition, it is flashed at a temperature of from 10 °C to 80 °C for from 5 to 60 minutes.

A forty-sixth aspect is directed to the method according to any of aspects 42-44, where prior to curing the applied curable composition, it is flashed at a temperature of from 20 °C to 60 °C, such as from 20 °C to 40 °C, or from 20 °C to 30 °C for from 5 to 30 minutes.

A forty-seventh aspect is directed to a method of preparing a polyurethane resin that comprises:
reacting a polyisocyanate with an acid containing polyol to form a polyurethane prepolymer; and
reacting the polyurethane prepolymer with an isocyanate reactive group to form a polyurethane resin having acid functional groups, the polyurethane resin having an acid value of at least 75 mg KOH on resin solids according to ASTM D 4662-15; and/or
reacting a polyisocyanate with a polyol to form a polyurethane prepolymer; and
reacting the polyurethane prepolymer with an isocyanate reactive group comprising hydroxyl groups; and
reacting the hydroxyl groups of the isocyanate reactive group with an acid monomer to form a polyurethane resin having acid functional groups, the polyurethane resin having an acid value of at least 75 mg KOH on resin solids according to ASTM D 4662-15; and/or
reacting a polyisocyanate with a polyol to form a polyurethane prepolymer; and
reacting the polyurethane prepolymer with an acid monomer to form a polyurethane resin having acid functional groups, the polyurethane resin having an acid value of at least 75 mg KOH on resin solids according to ASTM D 4662-15; and/or
reacting a polyisocyanate with a polyol to form a polyurethane prepolymer; and
reacting the polyurethane prepolymer with an acid monomer to form a polyurethane resin having acid functional groups, the polyurethane resin having an acid value of at least 75 mg KOH on resin solids according to ASTM D 4662-15.

A forty-eighth aspect is directed to the method of aspect 47, further comprising neutralizing the polyurethane resin with a neutralizing amine, such as from 40-120%, of the acid groups in the polyurethane resin.

A forty-ninth aspect is directed to the method of aspect 47, further comprising neutralizing the polyurethane resin with a neutralizing amine, such as from 40-100%, or from 40-95% or from 60-100%, or from 80-95%, of the acid groups in the polyurethane resin.

A fiftieth aspect is directed to the method of any of aspects 47-49, where the neutralizing amine is selected from a tertiary amine, ammonia, and combinations of the foregoing.

A fifty-first aspect is directed to the method of any one of aspects 47-50, further comprising dispersing the polyurethane resin in water.

A fifty-second aspect is directed to the method of any one of aspects 47-51, where the isocyanate reactive group is diethanol amine.

### EXAMPLES

Aspects of the present disclosure are further illustrated by reference to the following examples. It will be apparent to those skilled in the art that many modifications, both to materials, and methods, may be practiced without departing from the scope of the disclosure.

NCO equivalent weight (in grams per equivalent; g/eq) was determined using ASTM D2572-19 (Standard Methods of Isocyanate Groups in Urethane Materials or Prepolymers) revised as follows: A dibutylamine solution of 78 g dibutylamine (available from Sigma Aldrich) in 4 liters of N-methyl-2-pyrrolidone (available from Fisher Scientific) was prepared in advance of sample testing. A sample having a weight between 1 and 2 grams was weighed accurately into a flask. The sample was reacted with 33 ml of the dibutylamine to form a substituted urea. The excess dibutylamine was then back-titrated with a solution of 0.2N hydrochloric acid in isopropyl alcohol (solution available from Fisher Scientific-Ricca). The amount of hydrochloric acid used to back-titrate the excess dibutylamine was used to calculate NCO equivalent weight of the original sample.

### Example 1: Formation of Polyurethane—Anhydride Ring Opening

A polyurethane resin was prepared according to the formulation of Table 1.

To a four necked reaction flask outfitted with a stirrer, gas inlet, thermometer and condenser was added the contents of Charge 1. After the exotherm subsided, the temperature was raised to 80 °C and held for 3 hours. The NCO equivalent weight was measured (1286 g/eq, theory 1290 g/eq). The reaction was cooled to 50 °C. Charge 2 was added and reaction was allowed to exotherm. Once the exotherm subsided the reaction was held at 65 °C until the NCO level was undetectable as measured by Fourier Transform Infrared (FTIR) Spectroscopy. Charge 3 was added. The reaction was heated to 80 °C and held until the cyclic anhydride was undetectable via FTIR. An aqueous dispersion was produced by adding Charge 4 and Charge 5. The final dispersion had a measured solids content of 37.7 wt % (determined by comparing an initial sample weight with a final sample weight after exposure to 110 °C for one hour), and measured acid value of 87 mg KOH/g on resins solids.

TABLE 1
Polyurethane Dispersion PUD-1

| Charge | Raw Material | Amount (g) |
|---|---|---|
| 1 | PolyTHF 650¹ | 325.0 |
| | Dimethyol Propionic Acid | 134.0 |
| | Isophorone Diisocyanate | 444.0 |
| | Dibutyltin Dilaurate | 0.45 |
| | Methyl Ethyl Ketone | 387.2 |
| 2 | Diethanol Amine | 105.4 |
| | Methyl Ethyl Ketone | 45.0 |
| 3 | Methylhexahydrophthalic | 168.8 |
| | Anhydride | |
| | Methyl Ethyl Ketone | 71.9 |
| 4 | Triethyl Amine | 143.7 |
| 5 | Deionized Water | 1538.1 |

¹Available from BASF

### Example 2: Formation of Polyurethane—Anhydride Ring Opening

A polyurethane resin was prepared according to the formulation of Table 2.

To a four necked reaction flask outfitted with a stirrer, gas inlet, thermometer and condenser was added the contents of Charge 1 and was heated to 50 °C allowing the reaction to exotherm. After the exotherm subsided the reaction was held at 75 °C for one hour. The NCO equivalent weight was measured (theory 1268 g/eq, measured 1391 g/eq). The reaction was cooled to 50 °C by the assistance of adding Charge 2. Charge 3 was added followed by Charge 4 letting the reaction exotherm. Once the exotherm had subsided, the reaction was held at 60 °C until NCO was undetectable as measured by FTIR. Charge 5 was added and the reaction was held at 80 °C until the anhydride peak did not change as measured by FTIR. The final polyurethane had a measured solids content of 74.2 wt % and a measured acid value of 93.3 mg/KOH on resin solids.

TABLE 2
Polyurethane Dispersion PUD-2

| Charge | Raw Material | Amount (g) |
|---|---|---|
| 1 | PolyTHF 650¹ | 63.2 |
| | 1,6-hexandiol | 22.9 |
| | Isophorone Diisocyanate | 86.3 |
| | Dibutyltin Dilaurate | 0.09 |
| | Methyl Ethyl Ketone | 7.9 |
| 2 | Methyl Ethyl Ketone | 98.4 |
| 3 | Diethanol Amine | 18.6 |
| 4 | Methyl Ethyl Ketone | 18.7 |
| 5 | Succinic Anhydride | 39.0 |
| | Methyl Ethyl Ketone | 46.6 |

¹Available from BASF

### Example 3: Formation of Polyurethane—Incorporation of Carboxylic Acid

A polyurethane resin was prepared according to the formulation of Table 3.

To a four necked reaction flask outfitted with a stirrer, gas inlet, thermometer and condenser was added the contents of Charge 1. After the exotherm subsided, the temperature was raised to 80 °C and held for 3 hours. The NCO equivalent weight was measured (1831 g/eq, theory 1799 g/eq). The reaction was cooled to 50 °C. Charge 2 was added and reaction was allowed to exotherm. Once the exotherm subsided the reaction was held at 65 °C until the NCO was undetectable as measured by FTIR. Charge 3 was added. An aqueous dispersion was produced by adding Charge 4. The final dispersion had a measured solids content of 38.1 wt. %, measured acid value of 75 mg KOH/g on resins solids.

TABLE 3
Polyurethane Dispersion PUD-3

| Charge | Raw Material | Amount (g) |
|---|---|---|
| 1 | PolyTHF 650¹ | 130.0 |
| | Dimethyol Propionic Acid | 107.2 |
| | Isophorone Diisocyanate | 266.4 |
| | Dibutyltin Dilaurate | 0.25 |
| | Methyl Ethyl Ketone | 215.8 |
| 2 | Diethanol Amine | 41.3 |
| | Methyl Ethyl Ketone | 17.8 |
| 3 | Triethyl Amine | 56.6 |
| 4 | Deionized Water | 722.0 |

¹Available from BASF

### Example 4: Formation of Polyurethane—Incorporation of Carboxylic Acid

A polyurethane resin was prepared according to the formulation of Table 4.

To a four necked reaction flask outfitted with a stirrer, gas inlet, thermometer and condenser was added the contents of Charge 1 and was heated to 50 °C allowing the reaction to exotherm. After exotherm subsided the reaction was held at 75 °C for six hours. The NCO equivalent weight was measured (theory 1799 g/eq, measured 1959 g/eq). The reaction was cooled to 50 °C by the assistance of adding Charge 2. Charge 3 was added followed by Charge 4 letting the reaction exotherm. Once the exotherm had subsided, the reaction was held at 65 °C until NCO was undetectable as measured by FTIR. The final polyurethane had a measured solids content of 56.0 wt. % and a measured acid value of 78.1 mg/KOH on resin solids.

TABLE 4
Polyurethane Dispersion PUD-4

| Charge | Raw Material | Amount (g) |
|---|---|---|
| 1 | PolyTHF 650¹ | 65.0 |
| | Dimethyol Propionic Acid | 53.6 |
| | Isophorone Diisocyanate | 133.2 |
| | Dibutyltin Dilaurate | 0.13 |
| | Methyl Ethyl Ketone | 110.0 |
| 2 | Methyl Ethyl Ketone | 128.7 |
| 3 | Dibutyl Amine | 22.7 |
| 4 | Methyl Ethyl Ketone | 37.8 |

¹Available from BASF

### Example 5: Formation of Polyurethane—Hydroxy Acid

A polyurethane was prepared according to the formulation of Table 5.

To a four necked reaction flask outfitted with a stirrer, gas inlet, thermometer and condenser was added the contents of Charge 1. After the exotherm subsided, the temperature was raised to 80 °C and held for 5 hours. The NCO equivalent weight was measured (1350 g/eq, theory 1290 g/eq). Charge 2 was added and reaction was held the reaction was held at 80 °C until the NCO was undetectable as measured by FTIR. An aqueous dispersion was produced by adding Charge 3 and Charge 4. The final dispersion had a measured solids content of 38.9 wt. % and a theoretical acid value of 108 mg KOH/g on resin solids.

TABLE 5
Polyurethane Dispersion PUD-5

| Charge | Raw Material | Amount (g) | Wt. % |
|---|---|---|---|
| 1 | PolyTHF 650¹ | 130.0 | 11.22 |
| | Dimethyol Propionic Acid | 53.6 | 4.63 |
| | Isophorone Diisocyanate | 177.6 | 15.34 |
| | Dibutyltin Dilaurate | 0.18 | 0.02 |
| | Methyl Ethyl Ketone | 154.8 | 13.37 |
| 2 | Hydroxy Pivalic Acid | 45.1 | 3.89 |
| | Methyl Ethyl Ketone | 19.4 | 1.68 |
| 3 | Triethyl Amine | 55.32 | 4.78 |
| 4 | Deionized Water | 522 | 45.07 |

¹Available from BASF

### Example 6: Formation of Polyurethane—Mercapto acids

A polyurethane was prepared according to the formulation of Table 6.

To a four necked reaction flask outfitted with a stirrer, gas inlet, thermometer and condenser was added the contents of Charge 1. After the exotherm subsided, the temperature was raised to 75 °C and held for 5 hours. The NCO equivalent weight was measured (1312 g/eq, theory 1290 g/eq). The reaction was cooled to 65 °C. Charge 2 was added followed by Charge 3. The reaction was held at 75 °C until the NCO was undetectable as measured by IR. An aqueous dispersion was produced by adding Charge 3 and Charge 4. The final dispersion had a measured solids content of 44.3 wt. % and a theoretical acid value of 101 mg KOH/g on resin solids.

TABLE 6
Polyurethane Dispersion PUD-6

| Charge | Raw Material | Amount (g) |
|---|---|---|
| 1 | PolyTHF 650¹ | 97.5 |
| | Dimethyol Propionic Acid | 40.2 |
| | Isophorone Diisocyanate | 133.2 |
| | Dibutyltin Dilaurate | 0.135 |
| | Methyl Ethyl Ketone | 116.1 |
| 2 | 3 Mercaptopropionic Acid | 31.3 |
| | Methyl Ethyl Ketone | 13.7 |
| 3 | Triethyl Amine | 0.61 |
| 4 | Triethyl Amine | 41.4 |
| 5 | Deionized Water | 281.6 |

¹Available from BASF

### Example 7: Formation of a Branched Carbodiimide

A carbodiimide was prepared according to the formulation of Table 7.

To a four necked reaction flask outfitted with a stirrer, gas inlet, thermometer and condenser was added the contents of Charge 1 and heated to 160 °C. The reaction was held until the measured isocyanate value was greater than 384 g/eq. The reaction was cooled to room temperature which was facilitated by adding Charge 2. The resulting NCO prepolymer had a measured isocyanate value of 532 g/eq and 66.3 wt % solids. A portion of the NCO prepolymer and Charge 3 were heated to 70 °C and held for 1 hour. Charge 4 followed by Charge 5 were added and the reaction was held at 80 °C until the NCO was undetectable via IR analysis. The reaction was dispersed by adding Charge 6. The dispersed materials had a solids content of 34.2 wt. % and a theory carbodiimide equivalent weight of 646 g/eq on resin solids.

TABLE 7
Branched carbodiimide CDI-1

| Charge | Raw Material | Amount (g) |
|---|---|---|
| 1 | Desmodur W¹ | 944.7 |
| | Phospholene Oxide | 2.5 |
| | Butyl Acetate | 94.4 |
| 2 | Butyl Actetate | 311.4 |
| 1 + 2 | NCO prepolymer | 319.2 |
| 3 | Dibutyltin Dilaurate | 0.036 |
| | MPEG 550² | 165.0 |
| | Butyl Acetate | 8.5 |
| 4 | TMP-EO³ | 17.4 |
| 5 | Butyl Acetate | 1.7 |
| 6 | Deionized Water | 656 |

¹liquid cycloaliphatic diisocyanate available from Covestro AG
²CARBOWAX Methoxypolyethylene Glycol 550 available from Dow Chemical
³Trimethylolpropane ethoxylate available from Sigma Aldrich average Mₙ~170

### Example 8: Curable Composition Including Carbodiimide

Curable compositions were prepared according to the formulations of Table 8. The polyurethane dispersion, water, and silicone surfactant were mixed in a 20 ml glass scintillation vial before Carbodilite V-02-L2 (available from Nisshinbo Chemical) was added and thoroughly stirred. The formulas were sprayed using a SataJet 4000 B HVLP with a WSB fluid tip on to 4″×12″ steel substrate which was precoated with an ED7100 electrocoat primer (available from ACT Test Panels LLC (Hillsdale, MI)) which had been processed and baked according to the manufacture's recommendations. The films were flashed at ambient conditions for 15 minutes before being baked in a 60 °C oven for 40 minutes. Each coated panel was allowed to sit for 7 days at ambient conditions before being subjected to solvent resistance testing.

TABLE 8
Curable Composition A-C

| | Example A | Example B | Example C |
|---|---|---|---|
| Component | Amount (g) | Amount (g) | Amount (g) |
| PUD-1 | 35.0 | 0 | 0 |
| PUD-3 | 0 | 7.5 | 0 |
| PUD-6 | 0 | 0 | 5.0 |
| Silicone | 0 | 0.1 | 0.1 |
| Surfactant¹ | | | |
| Deionized | 4.2 | 1.7 | 3.7 |
| Water | | | |
| Carbodiimide² | 21.2 | 0 | 0 |
| Carbodiimide³ | 0 | 3 | 0 |
| CDI-1 | 0 | 0 | 7.5 |

¹BYK348 available from BYK
²Carbodilite V-02-L2 available from Nisshinbo Chemical.
³Carbodilite E-09S available from Nisshinbo Chemical.

### Example 9: Curable Composition Including Epoxy

Curable compositions were prepared according to the formulations of Table 9. The polyurethane dispersion, water, and silicone surfactant were mixed before Denacol EX 614B (available from Nagase America LLC) was added and thoroughly stirred. The formulas Example D through F were drawn down using a 8 mil gap square applicator on to 4″×12″ steel substrate which was precoated with an ED6421HE electrocoat primer (available from ACT Test Panels LLC (Hillsdale, MI)), or with an ED7100 electrocoat primer (available from ACT Test Panels LLC (Hillsdale, MI)). The films were flashed at ambient conditions for 15 minutes before being baked in a 140 °C oven for 60 minutes. Example G was applied using #26 wire drawdown bar over a 0.0080-inch-thick 5182-H48 aluminum substrate pretreated with Cr-VI Henkel 702 Pretreatment (Available from Alcoa Weirton, WV). The coating was then immediately placed in Hendinair oven set at 281 °C. The settings of the Hendinair oven were used to achieve a peak metal temperature of 240 °C for a time of 10 seconds. Each coated panel was allowed to sit for 7 days at ambient conditions before being subjected to solvent resistance testing.

TABLE 9
Curable Composition D-G

| | Example D | Example E | Example F | Example G |
|---|---|---|---|---|
| Component | Amount (g) | Amount (g) | Amount (g) | Amount (g) |
| PUD-3 | 7.5 | 0 | 0 | 0 |
| PUD-5 | 0 | 10 | 0 | 0 |
| PUD-6 | 0 | 0 | 10 | 25 |
| Silicone | 0.10 | 0.09 | 0.09 | 0.23 |
| Surfactant¹ | | | | |
| DI Water | 2.6 | 4.4 | 6.2 | 46.6 |
| Epoxy² | 0.7 | 1.3 | 1.3 | 3.2 |

¹BYK348 available from BYK.
²Denacol ™ EX-614B available from Nagase America LLC.

### Example 10: Curable Composition Including Oxazoline

Curable compositions were prepared according to the formulations of Table 10. The polyurethane dispersion, water, and silicone surfactant were mixed in a 20 ml glass scintillation vial before Epocros WS-500 (available from Nippon Shokubai CO. LTD.) was added and thoroughly stirred. The formulas were drawn down using an 8 mil gap square applicator on to 4″×12″ steel substrate which was precoated with an ED6421HE electrocoat primer (available from ACT Test Panels LLC (Hillsdale, MI)) which had been processed and baked according to the manufacture's recommendations. The films were flashed at ambient conditions for 15 minutes before being baked in a 100 °C oven for 45 minutes. Each coated panel was allowed to sit for 1 day at ambient conditions before being subjected to solvent resistance testing.

TABLE 10
Curable Composition H-J

| | Example H | Example I | Example J |
|---|---|---|---|
| Component | Amount (g) | Amount (g) | Amount (g) |
| PUD-3 | 7.5 | 0 | 0 |
| PUD-5 | 0 | 5.0 | 0 |
| PUD-6 | 0 | 0 | 5.0 |
| Silicone | 0.1 | 0.05 | 0.05 |
| Surfactant¹ | | | |
| Water | 1.5 | 2 | 2.1 |
| Oxazoline² | 2.4 | 2.1 | 2.2 |

¹BYK348 available from BYK.
²Epocros ™ WS-500 available from Nippon Shokubai CO. LTD.

### Example 11: Curable Composition Including Aziridines

Curable compositions were prepared according to the formulations of Table 11. The polyurethane, NeoAdd PAX-523 (available from Covestro AG), and methyl ethyl ketone were mixed and thoroughly stirred. The formulas were drawn down using an 8 mil gap square applicator on to 4″×12″ steel substrate which was precoated with an ED7100 electrocoat primer (available from ACT Test Panels LLC (Hillsdale, MI)) which had been processed and baked according to the manufacture's recommendations. The films were flashed at ambient conditions for 5 minutes before being baked in a 140 °C oven for 30 minutes. Each coated panel was allowed to sit for 7 days at ambient conditions before being subjected to solvent resistance testing.

TABLE 11
Curable Composition K-L

| | Example K | Example L |
|---|---|---|
| Component | Amount (g) | Amount (g) |
| PUD-2 | 32.3 | 0 |
| PUD-4 | 0 | 45.9 |
| Polyazirdine¹ | 20.1 | 17.9 |
| Methyl Ethyl Ketone | 47.6 | 36.2 |

¹NeoAdd PAX-523 available from Covestro AG

### Example 12: Curable Composition Properties

A Solvent Resistance Test was performed on each example curable composition of Tables 5-11 using the procedure described in the description above. The results of the Solvent Resistance Test as recorded in MEK double rubs can be seen in Table 12, below.

TABLE 12
Curable composition A-L

| Example | MEK Double Rubs |
|---|---|
| A | 100 |
| B | 100 |
| C | 100 |
| D | 100 |
| E | 100 |
| F | 100 |
| G | 100 |
| H | 100 |
| I | 100 |
| J | 100 |
| K | 100 |
| L | 100 |

As can be seen in the above examples, a variety of polyurethanes that include acid functional groups were used to create curable compositions as shown by excellent solvent resistance according to the Solvent Resistance Test. Further, it was demonstrated that the acid functional groups on the polyurethanes can be installed using a variety of synthetic approaches, all of which yielded curable moieties. Additionally, a number of different curing agents or crosslinkers, reactive with the acid functional groups, were demonstrated as part of the curable compositions.

Whereas particular examples of the compositions and methods according to this disclosure have been described above for purposes of illustration, it will be evident to those skilled in the art that numerous variations of the details of the present disclosure may be made without departing from the description as defined in the appended claims.

1. A curable composition comprising:
a polyurethane resin having acid functional groups, the polyurethane resin having an acid value of at least 75 mg KOH on resin solids according to ASTM D 4662-15.

2. The curable composition of claim 1, further comprising at least one of water, an organic solvent, and combinations thereof; and/or an amine, such as a catalytic amine and/or a neutralizing amine.

3. The curable composition of claim 2, wherein the amine is a tertiary amine.

4. The curable composition of claim 1, wherein the polyurethane resin has a number average molecular weight, of from 400 g/mol to 50,000 g/mol determined by gel permeation chromatography using polystyrene standards.

5. The curable composition of claim 1, wherein the curable composition comprises the polyurethane resin at from 20 wt. % to 85 wt. where wt. % is based on total resin solids.

6. The curable composition of claim 1, wherein the acid functional groups comprise the residue of an acid monomer comprising an anhydride, and/or an isocyanate reactive group; and/or wherein the acid functional groups comprise the residue of an acid monomer comprising one or both of a hydroxy acid and a mercapto acid, such as hydroxy pivalic acid, 3-mercaptopropionic acid, 2-mercaptopropionic acid, and/or 2-mercaptoacetic acid.

7. The curable composition of claim 1, further comprising at least one of a carbodiimide, an epoxy, an oxazoline, and an aziridine.

8. The curable composition of claim 1, wherein
the polyurethane resin is part of a polyurethane resin composition comprising from 0 wt. % to 95 wt. % of an organic solvent, where wt. % is based on a total weight of the polyurethane resin composition.

9. The curable composition of claim 1, comprising a catalyst, such as zinc, an amine, a quaternary ammonium compound, a phosphonium containing compound, and/or a quaternary phosphonium group containing compound in an amount of from 0.1 wt. % to 5 wt. %, where wt. % is based on the resin solids of the coating composition.

10. A method of preparing a polyurethane resin comprising:
reacting a polyisocyanate with an acid containing polyol to form a polyurethane prepolymer; and
reacting the polyurethane prepolymer with an isocyanate reactive group to form a polyurethane resin having acid functional groups, the polyurethane resin having an acid value of at least 75 mg KOH on resin solids according to ASTM D 4662-15; and/or
reacting a polyisocyanate with a polyol to form a polyurethane prepolymer; and
reacting the polyurethane prepolymer with an isocyanate reactive group including hydroxyl groups; and
reacting the hydroxyl groups of the isocyanate reactive group with an acid monomer to form a polyurethane resin having acid functional groups, the polyurethane resin having an acid value of at least 75 mg KOH on resin solids according to ASTM D 4662-15; and/or
reacting a polyisocyanate with a polyol to form a polyurethane prepolymer; and
reacting the polyurethane prepolymer with an acid monomer to form a polyurethane resin having acid functional groups, the polyurethane resin having an acid value of at least 75 mg KOH on resin solids according to ASTM D 4662-15; and/or
reacting a polyisocyanate with a polyol to form a polyurethane prepolymer; and
reacting the polyurethane prepolymer with an acid monomer to form a polyurethane resin having acid functional groups, the polyurethane resin having an acid value of at least 75 mg KOH on resin solids according to ASTM D 4662-15.

11. The method of claim 10, further comprising neutralizing the polyurethane resin with a neutralizing amine, such as from 40-120% of the acid groups in the polyurethane resin.

12. The method of claim 11, wherein the neutralizing amine is selected from a tertiary amine, ammonia, and combinations of the foregoing.

13. The method of claim 1, further comprising dispersing the polyurethane resin in water.

14. The method of claim 10, wherein the isocyanate reactive group is diethanol amine.

15. A method of coating a substrate comprising applying the curable composition of claim 1 over at least a part of a substrate using spray coating, roller coating, coil coating, dip coating, precision coating, or spin coating techniques and curing the curable composition to form a cured layer or an article.

16. The method of claim 15, wherein the article or cured layer has a solvent resistance of at least 100 MEK double rubs.

17. The method according to claim 15, wherein the curable composition is cured at a temperatures of from 0 °C to 260 °C for from 5 seconds to 48 hours.

18. The method according to claim 15, wherein prior to curing the applied curable composition, it is flashed at a temperature of from 10 °C to 80 °C from 5 to 60 minutes.
